(19) United States
(12) Patent Application Publication
(10) Pub. No.: US 2014/0286318 A1
(43) Pub. Date: Sep. 25, 2014

(54) SCHEDULING METHOD AND SCHEDULING DEVICE

(71) Applicant: FUJITSU LIMITED, Kawasaki-shi (JP)

(72) Inventor: Hiroaki SENOO, Kawasaki (JP)

(73) Assignee: FUJITSU LIMITED, Kawasaki-shi (JP)

(21) Appl. No.: 14/213,483

(22) Filed: Mar. 14, 2014

(30) Foreign Application Priority Data
Mar. 19, 2013 (JP) 2013-056677

(51) Int. Cl. H04W 72/12; H04W 72/04

(52) U.S. Cl. CPC H04W 72/1268; H04W 72/0446
USPC 370/336

(57) ABSTRACT

A scheduling method by a scheduling device, the scheduling method including: receiving a first signal including a plurality of first reference signals from a terminal, the plurality of first reference signals being time multiplexed and having a same frequency, estimating a frequency deviation of the first signal based on the plurality of first reference signals of the first signal, transmitting a second signal to the terminal based on the frequency deviation, the second signal instructing the terminal to transmit a third signal in which the plurality of first reference signals and a second reference signal are time multiplexed in a specified period and have a same frequency.

### CROSS-REFERENCE TO RELATED APPLICATION

This application is based upon and claims the benefit of priority of the prior Japanese Patent Application No. 2013-056677, filed on Mar. 19, 2013, the entire contents of which are incorporated herein by reference.

### FIELD

An aspect of the present disclosure relates to a scheduling method and a scheduling device in a wireless communication system.

### BACKGROUND

In a radio mobile communication system, a deviation may occur between a transmission carrier frequency transmitted from a mobile station and a reception carrier frequency received by a base station.

For example, when a frequency deviation occurs between a mobile station and a base station, the phase of received signals appear to be rotating.

Thus, when the phase of a signal is determined which has been modulated by, for example, binary phase shift keying (BPSK) or quadrature phase shift keying (QPSK), the frequency deviation may cause deterioration of reception characteristics.

Examples of technology for estimating and correcting a frequency deviation include the technology disclosed in International Publication Pamphlet No. WO 2010/21014 and Japanese Laid-open Patent Publication No. 2009-283992.

### SUMMARY

According to an aspect of the invention, a scheduling method by a scheduling device, the scheduling method includes receiving a first signal including a plurality of first reference signals from a terminal, the plurality of first reference signals being time multiplexed and having a same frequency, estimating a frequency deviation of the first signal based on the plurality of first reference signals of the first signal, transmitting a second signal to the terminal based on the frequency deviation, the second signal instructing the terminal to transmit a third signal in which the plurality of first reference signals and a second reference signal are time multiplexed in a specified period and have a same frequency.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an illustration schematically depicting an example of a radio mobile communication system according to an embodiment;

FIG. 2 is an explanatory illustration for carrier aggregation (CA);

FIG. 3 is a diagram illustrating examples of respective frame formats (time domain) for a physical uplink control channel (PUCCH), a physical uplink shared channel (PUSCH), and a sounding reference signal (SRS);

FIG. 4 is a diagram schematically illustrating a frequency deviation estimation method for a PUCCH;

FIG. 5 is a diagram schematically illustrating a frequency deviation estimation method for a PUSCH;

FIG. 6 is a block diagram illustrating a configuration example of a base station (eNB) illustrated in FIG. 1;

FIG. 7 is a chart illustrating an example of the operation of the eNB illustrated in FIGS. 1 and 6;

FIG. 8 is a chart schematically illustrating a frequency deviation estimation method performed by the eNB illustrated in FIGS. 1 and 6;

FIG. 9 is a flow chart illustrating the frequency deviation estimation method performed by the eNB illustrated in FIGS. 1 and 6;

FIG. 10 is a flow chart illustrating a phase angle conversion processing illustrated in FIG. 9;

FIGS. 11A and 11B are diagrams each illustrating the complex plane (IQ plane), FIG. 11A is a diagram illustrating the case where a result of calculation of θ1 in processing C of FIG. 9 indicates rotation in the negative direction, and FIG. 11B is a diagram illustrating the case where a result of calculation of θ1 in processing C of FIG. 9 indicates rotation in the positive direction;

FIGS. 12A and 12B are a diagrams schematically illustrating a phase angle conversion processing in processing E of FIG. 9;

FIG. 13 is a diagram illustrating a modification of the frequency deviation estimation method; and

FIG. 14 is a diagram illustrating another modification of the frequency deviation estimation method.

### DESCRIPTION OF EMBODIMENTS

However, related art does not consider the possibility that an estimation range of frequency deviation may be more narrowed compared with other physical channels because the transmission time interval of pilot signals is longer compared with other physical channels as in the below-described case of SCell. When the estimation range of frequency deviation is narrowed, precision of the estimation is reduced and the reception characteristics deteriorate.

An object of the present disclosure is to improve the precision of the estimation of frequency deviation.

Without being limited to the above-mentioned object, the present disclosure provides an operational effect which is not achieved by related art but achieved by the configuration presented as the best mode for practicing the below-described disclosure.

Hereinafter, an embodiment of the present disclosure will be described with reference to the drawings. However, the embodiment described below is an example, and it is not intended to exclude various modifications and technical application which are not explicitly stated below. It is to be noted that in the drawings referred in the following embodiment, components labeled with the same symbol indicate the same or a similar component unless otherwise stated.

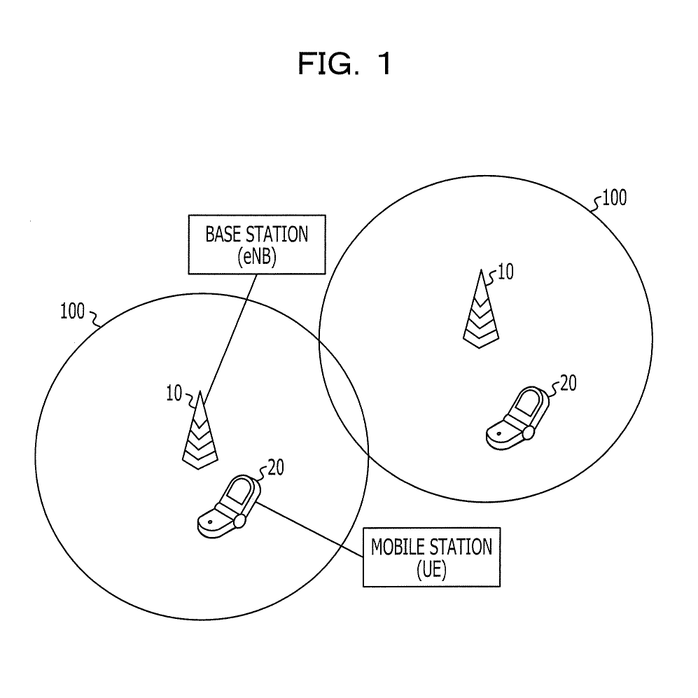

FIG. 1 is an illustration schematically depicting an example of a radio mobile communication system according to the embodiment. The radio mobile communication system illustrated in FIG. 1 includes an evolutional Node B (eNB) 10 which is an example of one or a plurality of radio base stations, and a user equipment (UE) 20 which is an example of one or a plurality of mobile stations. Each of the radio base stations and mobile stations is an example of a radio device.

The eNB 10 forms a cell 100 which is a connectable area, and performs mutual communication with one or a plurality of UEs 20 located in the cell 100 via a radio interface. The radio interface includes uplink (UL) channels and downlink (DL) channels. Each UL channel is used for signal transmission from the UE 20 to the eNB 10, and each DL channel is used for signal transmission from the eNB 10 to the UE 20.

On the other hand, radio mobile communication systems has a common problem of shortage of network capacity due to an increase of data traffic, and one of the solutions to this problem is a technology referred to as “carrier aggregation (CA)” which achieves high speed, large capacity communication.

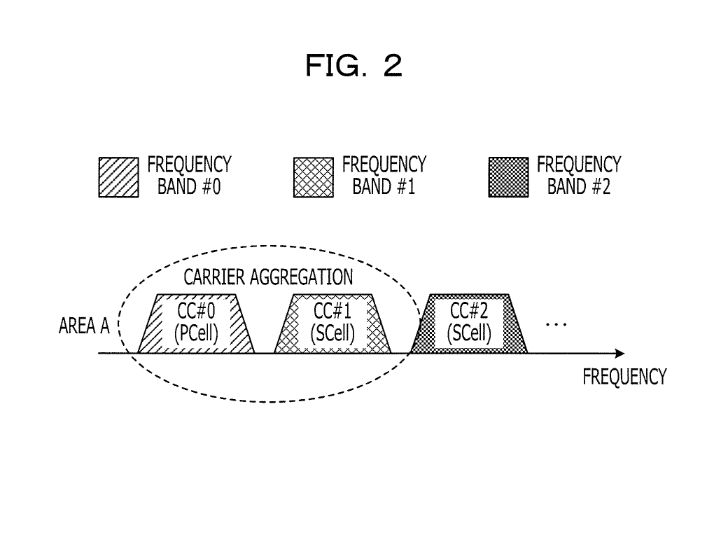

The CA allows the number of accommodated users and the maximum throughput to be increased by combining a plurality of continuous or discontinuous frequency bands (component carriers: CCs) and using the plurality of frequency bands at the same time (see FIG. 2). FIG. 2 illustrates the manner in which CC#0 (frequency band #0) and CC#1 (frequency band #1) are used at the same time.

The CCs are classified into primary cell (PCell) and secondary cell (SCell)s. Each of the PCell and SCell defines physical channels which may be transmitted in the UL channel (Reference Document 1: TS36.300 V10.6.0 5.2.3. Physical uplink control channel and 7.5. Carrier Aggregation).

That is, according to Reference Document 1, the PCell allows transmission of a physical random access channel (PRACH), a PUSCH, a PUCCH, and a SRS. On the other hand, the SCell allows transmission of the PUSCH and the SRS. However, the SCell has a specification which does not allow transmission of the PRACH and the PUCCH.

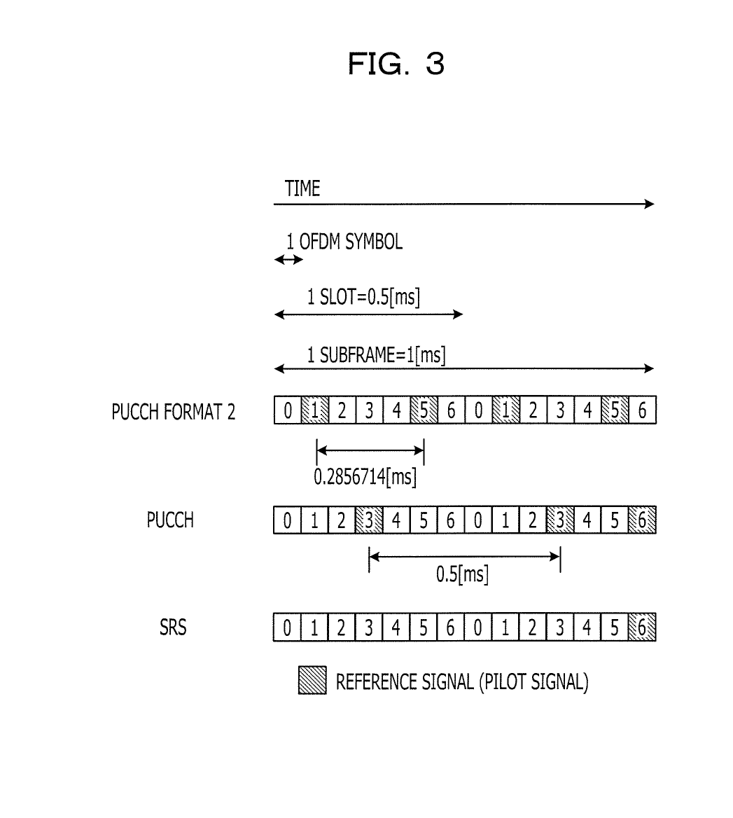

FIG. 3 illustrates examples of respective frame formats (time domain) for the PUCCH, PUSCH, and SRS (Reference Document 2: TS36.211 V10.4.0 5.5.2.1. Demodulation reference signal for PUSCH).

In each of the PUCCH and PUSCH, one subframe is 1 ms long and 2 time slots (=2×0.5 ms) are allocated to each subframe. Each time slot further includes orthogonal frequency division multiplexing (OFDM) symbols which are labeled with numbers 0 to 6, respectively.

In the PUCCH, a demodulation reference signal (DM-RS) is illustratively placed (time multiplexed) on all of the 1st and 5th OFDM symbols (hereinafter each simply referred to as a “symbol”) in one subframe (total of four symbols). The DM-RS is an example of a known signal (pilot signal) between the eNB 10 and the UE 20.

On the other hand, in the PUSCH, the DM-RS is illustratively placed on all of the 3rd OFDM symbols in one subframe (total of two symbols). The SRS is illustratively placed on the last OFDM symbol in one subframe.

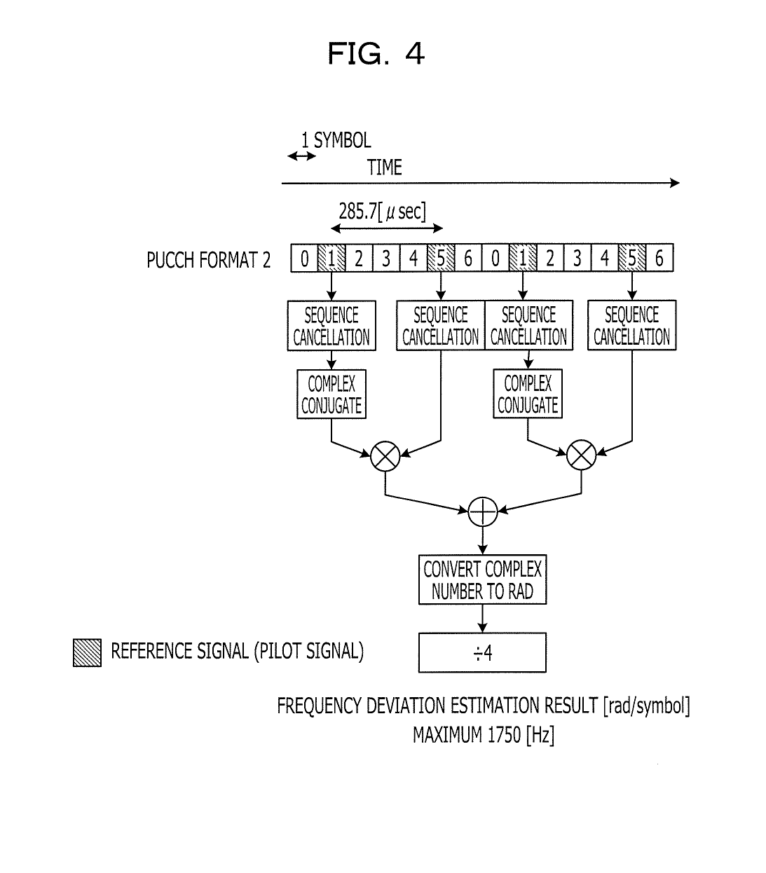

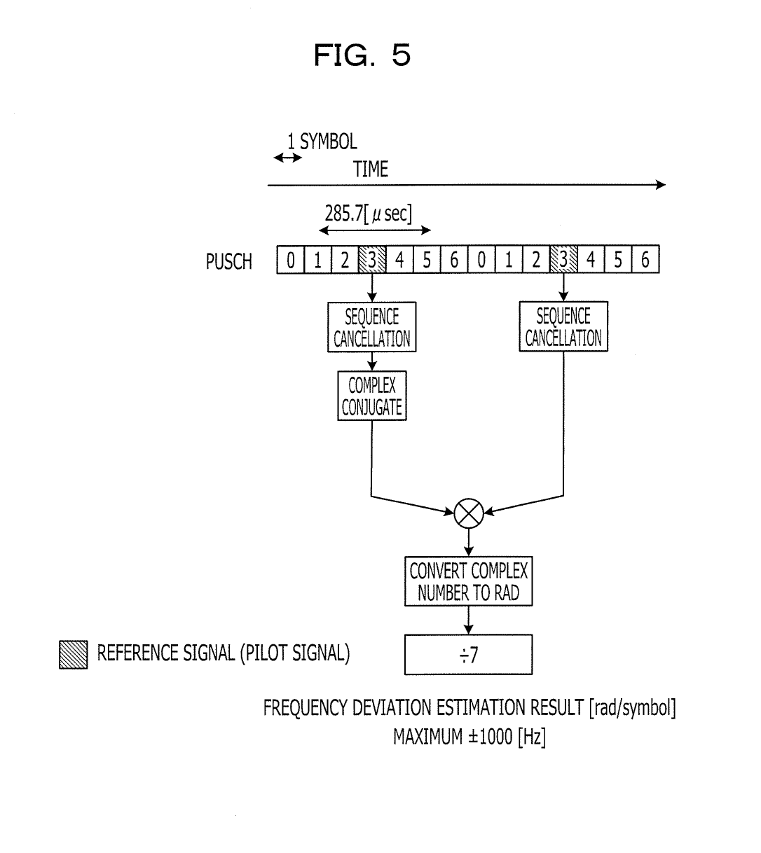

Here, as illustrated in FIG. 3, the time interval (for example, 0.5 ms) between the DM-RS in the PUSCH is longer than the time interval (0.2856714 ms) between the DM-RS in the PUCCH. For this reason, with the frequency deviation estimation method as illustrated in FIGS. 4 and 5, using a result of mutual correlation calculation between RSs, a possible estimation range of frequency deviation in the SCell, which does not allow transmission of the PUCCH, is more narrowed compared with the PCell. When the possible estimation range of frequency deviation is narrowed, precision of the estimation is reduced and the reception characteristics deteriorate.

FIG. 4 schematically illustrates the frequency deviation estimation method for the PUCCH, and FIG. 5 schematically illustrates the frequency deviation estimation method for the PUSCH. In each of the methods of FIGS. 4 and 5, the product of one RS and the complex conjugate of the other RS is calculated, and the result of the calculation is converted into a phase angle per symbol (rad/symbol), the one RS and the other RS being placed at two different times.

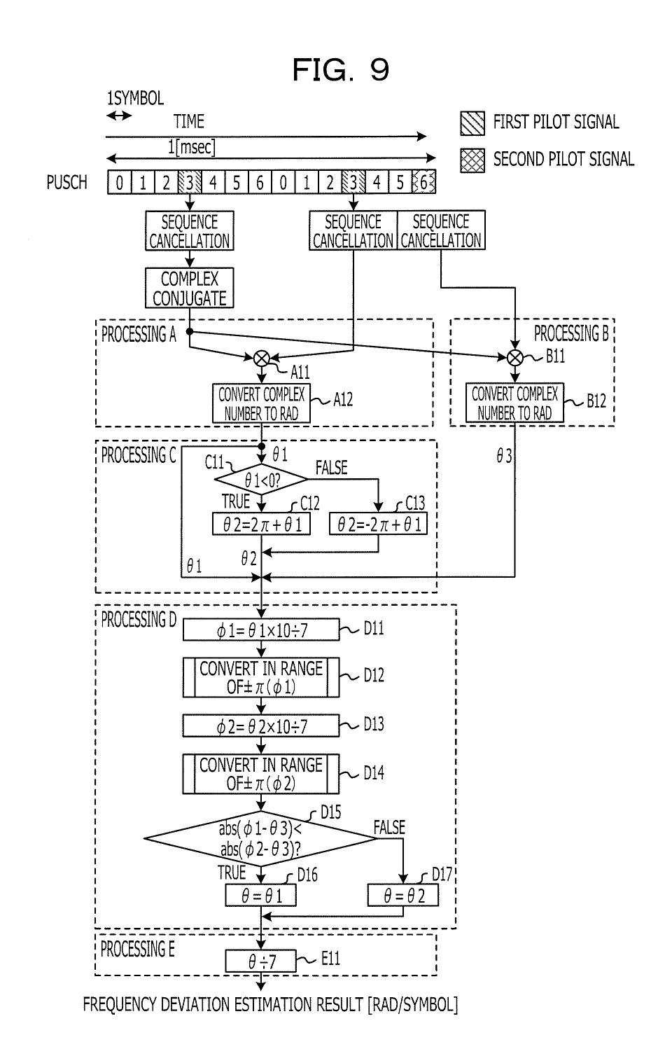

In FIG. 4 (similarly in FIGS. 9, 13, and 14), “sequence cancellation” indicates the processing of removing (cancelling) specific information (identification information) to the eNB 10, the specific information being superimposed on a received RS. For example, by multiplying a sequence specific to an eNB 10 by its complex conjugate sequence on the received RS, the sequence specific to the eNB 10 may be removed (cancelled) from the received RS so that each RS addressed to the specific eNB 10 may be extracted.

In order to avoid the above-described narrowing of the possible estimation range of frequency deviation and to expand the range, broadly speaking, the following processing 1 to 4 are performed in the present embodiment.

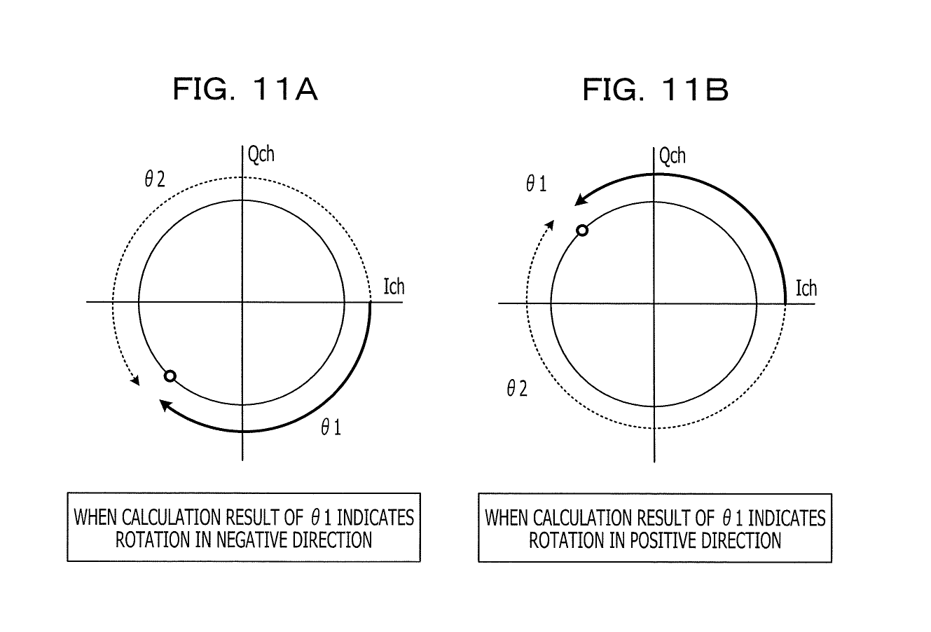

(Processing 1) In the eNB 10, two types of frequency deviation estimation values are calculated in addition to the frequency deviation estimation value (hereinafter may be referred to as a “narrow range estimation value”) illustrated in FIG. 5, the calculation being performed under the assumption of rotation of phase in the positive direction and rotation of phase in the negative direction based on the DM-RS of the PUSCH, the DM-RS being an example of a first pilot signal. The rotation in the positive direction indicates the counterclockwise rotation in the complex plane (IQ plane), and the rotation in the negative direction indicates the clockwise rotation in the IQ plane (for example, see FIGS. 11A and 11B).

(Processing 2) When the calculated narrow range estimation value is greater than or equal to a predetermined threshold value (for example, when it is estimated that the UE 20 is moving at a high speed), the eNB 10 performs scheduling (hereinafter may be referred to as a “simultaneous scheduling operation”) of the transmission timing of the first pilot signal (or a second pilot signal) from the UE 20 so as to have the receiving time of the first pilot signal (the DM-RS of the PUSCH) and the receiving time of SRS within the same subframe (hereinafter may be referred to as a “simultaneous receiving timing”), the SRS being an example of the second pilot signal.

(Processing 3) The eNB 10 selects one of the two types of frequency deviation estimation values calculated by the processing 1 at the simultaneous receiving timing based on the phase difference between the first pilot signal and the second pilot signal, the one being more probable, so as to obtain a frequency deviation estimation value (hereinafter may be referred to as a “wide range estimation value”).

(Processing 4) When the wide range estimation value is less than or equal to a predetermined threshold value (for example, when it is estimated that the UE 20 is moving at a low speed or standing still), the eNB 10 stops the simultaneous scheduling operation described in the processing 2.

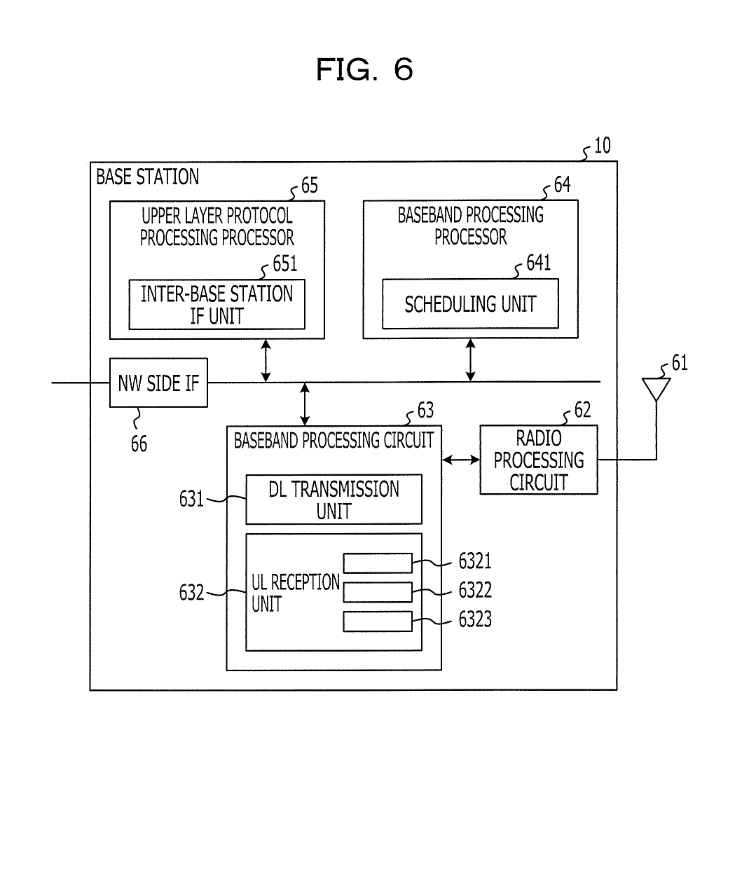

FIG. 6 illustrates a configuration example of the eNB 10 according to the present embodiment. The eNB 10 illustratively includes a base station antenna 61, a radio processing circuit 62, a baseband processing circuit 63, a baseband processing processor 64, an upper layer protocol processing processor 65, and a network (NW) side interface (IF) 66.

The base station antenna 61 transmits and receives radio signals to and from the UE 20.

The radio processing circuit 62 performs mutual conversion between a baseband frequency and a radio frequency.

The baseband processing circuit 63 performs processing for layer 1. The baseband processing circuit 63 illustratively includes a DL transmission unit 631 and a UL reception unit 632.

The DL transmission unit 631 instructs the UE 20 to transmit a first pilot signal. The UL reception unit 632 receives the first pilot signal and the second pilot signal to perform estimation processing of frequency deviation.

The UL reception unit 632 illustratively includes a frequency deviation estimation unit 6321, a phase rotation direction estimation unit 6322, and a selection unit 6323. The details of these units 6321 to 6323 will be described below.

The baseband processing processor 64 includes a scheduling unit 641 and performs control management of the layer 1 and layer 2. The scheduling unit 641 performs the simultaneous scheduling operation.

The upper layer protocol processing processor 65 includes an inter-base station interface (IF) unit 651 and performs processing of the layer 2, radio resource management, signal transmission and reception processing between eNBs, and upper layer protocol processing such as signal transmission and reception to and from network (NW) side devices via the NW side IF 66.

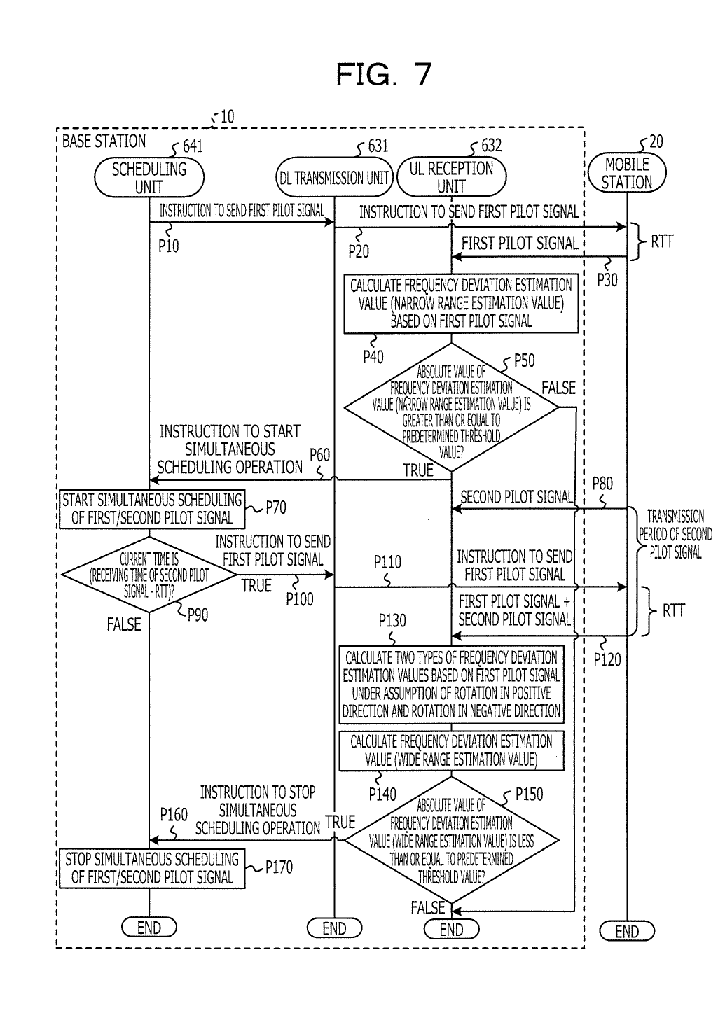

Next, FIG. 7 illustrates an example of scheduling processing according to the present embodiment. The scheduling unit 641 of the eNB 10 instructs the UE 20 to transmit the first pilot signal (for example, the DM-RS of the PUSCH) via the DL transmission unit 631 (processing P10 and P20).

After an elapse of a predetermined time since receiving the instruction from the eNB 10 for transmitting the first pilot signal, the UE 20 transmits the first pilot signal to the eNB 10 (processing P30). The predetermined time is illustratively a round trip time (RU), and in the case of long term evolution (LTE), the predetermined time is four subframes (4.0 ms). In other words, as a response to UL Grant signal from the eNB 10 to the UE 20, the first pilot signal is transmitted from the UE 20 after an elapse of four subframes since receiving the UL Grant.

After receiving the first pilot signal, the UL reception unit 632 of the eNB 10 calculates a frequency deviation estimation value (narrow range estimation value) based on the first pilot signal by the method illustrated in FIG. 5 (processing P40).

The UL reception unit 632 of the eNB 10 compares the absolute value of the calculated narrow range estimation value with a predetermined threshold value (a first threshold value) (processing P50). When the absolute value of the narrow range estimation value is greater than or equal to the threshold value (true in the processing P50), an instruction to start simultaneous scheduling is transmitted to the scheduling unit 641 (processing P60).

When the first threshold value is defined to be 80% of a possible maximum frequency deviation estimation value, for example, in FIG. 5, the threshold value is π×80[%]÷7=0.36[rad/symbol]. When the absolute value of the narrow range estimation value is less than the threshold value (false in the processing P50), the UL reception unit 632 terminates the processing.

After receiving the instruction to start simultaneous scheduling, the scheduling unit 641 starts simultaneous scheduling operation of the first and/or the second pilot signal (processing P70). For example, when the second pilot signal (for example, an SRS) is periodically received from the UE 20 (the processing P80 and the processing P120), the scheduling unit 641 checks to see whether or not the current time matches the time obtained by subtracting the RTT from the receiving time of the second pilot signal (processing P90).

When the current time matches the obtained time (true in the processing P90), the scheduling unit 641 transmits to the DL transmission unit 631 an instruction to send the first pilot signal (processing P100).

After receiving the instruction to send the first pilot signal from the scheduling unit 641, the DL transmission unit 631 transmits to the UE 20 the instruction to send the first pilot signal (processing P110). In other words, the scheduling unit 641 causes the DL transmission unit 631 to transmit to the UE 20 an instruction to send the first pilot signal so as to have the receiving time of the second pilot signal (for example, an SRS) and the receiving time of the first pilot signal both time multiplexed within the same time interval (subframe).

After an elapse of the RTT since receiving the instruction to send the first pilot signal, the UE 20 transmits the first pilot signal in addition to the second pilot signal at a transmission time of the second pilot signal, thereby transmitting to the eNB 10 the first and second pilot signals which are placed (time multiplexed) within the same time interval (subframe) (processing P120).

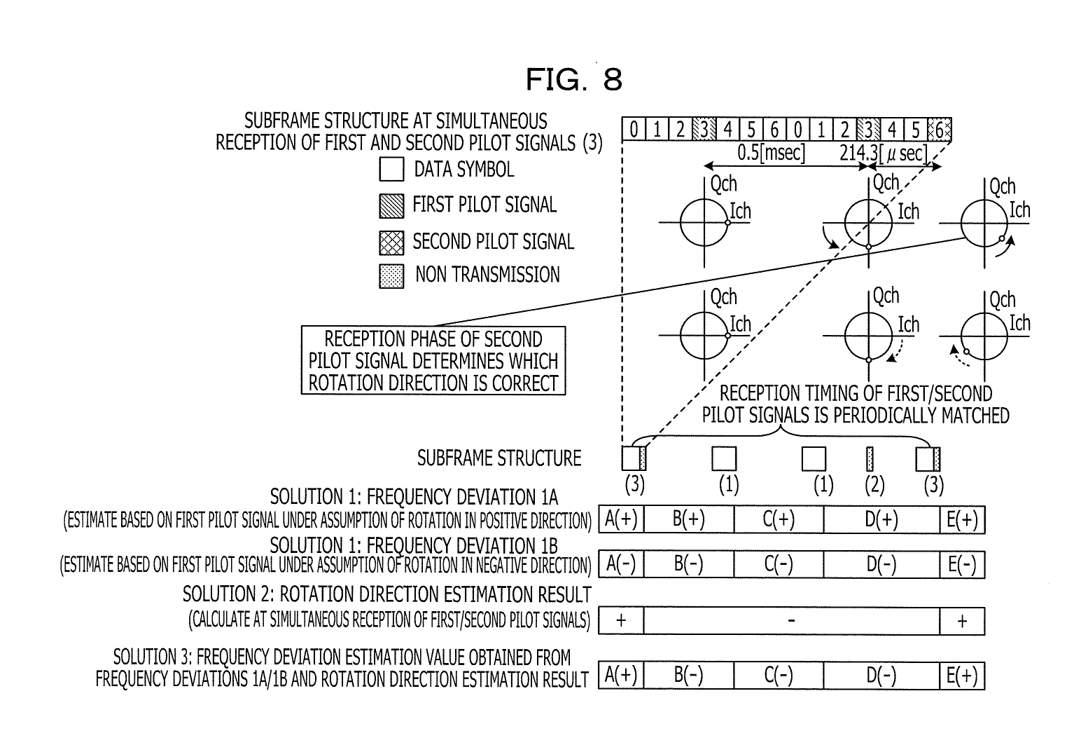

Upon receiving the first pilot signal and the second pilot signal placed in the same subframe, the eNB 10 causes the UL reception unit 632 to calculate two types of frequency deviation estimation values 1A and 1B, for example, as illustrated in FIG. 8 (solution 1) based on the received first pilot signal under the assumption of rotation in the positive direction and rotation in the negative direction (processing P130).

That is, the UL reception unit 632 has a function as the frequency deviation estimation unit 6321 (see FIG. 6) which calculates the two types of frequency deviation estimation values based on the first pilot signal under the assumption of rotation in the positive direction and rotation in the negative direction.

In FIG. 8, A(+), B(+), C(+), D(+), and E(+) indicate the frequency deviation estimation values 1A for five subframes A to E under the assumption of rotation in the positive direction, and A(−), B(−), C(−), D(−), and E(−) indicate the frequency deviation estimation values 1B for five subframes A to E under the assumption of rotation in the negative direction.

As illustrated in FIG. 8 (solutions 2 and 3), the UL reception unit 632 selects one of the frequency deviation estimation value 1A under the assumption of rotation in the positive direction and the frequency deviation estimation value 1B under the assumption of rotation in the negative direction, the one being more probable, based on the phase difference between the received first pilot signal and second pilot signal so as to obtain a frequency deviation estimation value (wide range estimation value) (processing P140).

That is, the UL reception unit 632 has a function as the phase rotation direction estimation unit 6322 (see FIG. 6) which estimates a phase rotation direction based on the second pilot signal at a time when the first pilot signal and the second pilot signal are time multiplexed within the same time interval. In addition, the UL reception unit 632 has a function as the selection unit 6323 (see FIG. 6) which selects one of the two types of frequency deviation estimation values 1A and 1B, the one being more probable, based on the estimated phase rotation direction.

FIG. 8 illustrates the case where the estimated result of rotation direction for the subframes A and E is plus (+), and the estimated result of rotation direction for the subframes B to D is minus (−). In this case, A(+), B(−), C(−), D(−), and E(+) are selected as the wide range estimation values for the subframes A to E, respectively.

The UL reception unit 632 compares each of the absolute values of the obtained wide range estimation values with a predetermined threshold value (a second threshold value) (processing P150). When the absolute value of the wide range estimation value is less than or equal to the threshold value (true in the processing P150), an instruction to stop the simultaneous scheduling operation is transmitted to the scheduling unit 641 (processing P160).

When the second threshold value is defined to be 70% of a possible maximum frequency deviation estimation value, for example, in FIG. 5, the threshold value is π×70[%]÷7=0.31[rad/symbol]. Here, the first threshold value is 80% of a possible maximum frequency deviation estimation value, and the second threshold value is 70% of a possible maximum frequency deviation estimation value so as to have different threshold values. Thus, frequent occurrence of start and stop of the simultaneous scheduling operation may be reduced.

Upon receiving the instruction to stop the simultaneous scheduling operation, the scheduling unit 641 stops the simultaneous scheduling operation (processing P170). When the absolute value of the wide range estimation value is less than the threshold value (false in the processing P150), the UL reception unit 632 terminates the processing (the simultaneous scheduling operation is continued).

Next, the details of the frequency deviation estimation processing performed by the above-described UL reception unit 632 will be described with reference to FIGS. 9 to 12.

As illustrated in FIG. 9, the UL reception unit 632 calculates the product (processing A11) of complex conjugates for the first pilot signals in the processing A, and converts a complex number as the calculation result into a phase rotation amount (processing A12), thereby determining the phase rotation amount θ1 [rad/7symbol] for seven symbols.

The UL reception unit 632 calculates the product (processing B11) of the first pilot signal and the complex conjugate of the second pilot signal in the processing B, and converts a complex number as the calculation result into a phase rotation amount (processing B12), thereby determining the phase rotation amount θ3 [rad/10symbol] for 10 symbols.

In processing C, the UL reception unit 632 further determines whether or not the phase rotation amount θ1 obtained by the processing A indicates rotation in the negative direction (whether θ1<0 or not) (processing C11). When θ1 indicates rotation in the negative direction as a result of the determination (true), a phase rotation amount θ2 (=2π+θ1) is calculated under the assumption of rotation in the positive direction as illustrated in FIG. 11A (processing C12). On the other hand, when θ1 indicates rotation in the positive direction (false), a phase rotation amount θ2 (=−2π+θ1) is calculated under the assumption of rotation in the negative direction as illustrated in FIG. 11B (processing C13).

Subsequently, the UL reception unit 632 converts the units of θ1 and θ2 from [rad/7symbol] to [rad/10symbol] by the following formula (processing D11 and D13).

φ1=θ1×10÷7

φ2=θ2×10 ÷7

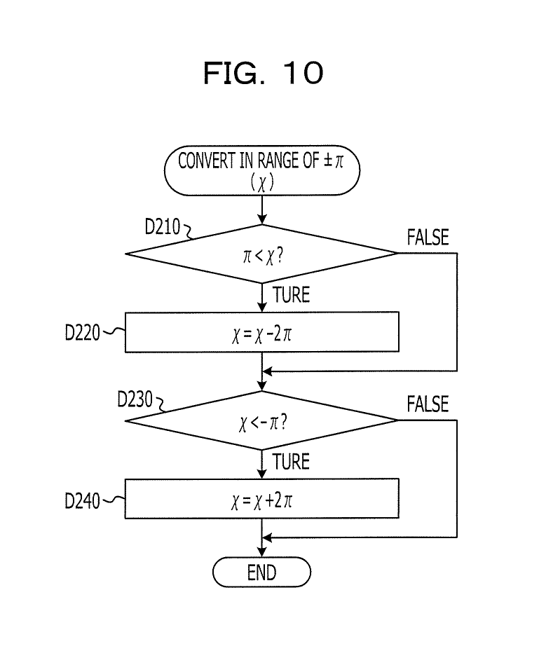

The UL reception unit 632 then converts φ1 and φ2 into the range of ±π [rad] (processing D12 and D14). That is, as illustrated in FIG. 10, the UL reception unit 632 first determines whether or not variable x is greater than π where x=φ1 or φ2 (processing D210).

When x is greater than it as a result of the determination (true), the UL reception unit 632 sets x=x−2π (processing D220). On the other hand, when x is less than or equal to it π (false), the UL reception unit 632 determines whether or not x is less than −π (processing D230).

When x is less than −π as a result of the determination (true), the UL reception unit 632 sets x=x+2π (processing D240). When x is greater than or equal to −π (false), the UL reception unit 632 terminates the conversion processing.

Subsequently, as illustrated in FIG. 9, the UL reception unit 632 determines whether or not the absolute value of φ2−θ3 [abs(φ2−θ3)] is greater than the absolute value of φ1−θ3 [abs(φ1−θ3)] (processing D15). That is, it is determined which value of φ1 and φ2 is closer to the phase rotation amount θ3 calculated by the processing B.

When a result of the determination indicates true, the UL reception unit 632 substitutes θ1 for θ (θ=θ1) because φ1 is closer to θ3 and θ1 is primarily used for the calculation of φ1 (processing D16). On the other hand, when the result of the determination indicates false, the UL reception unit 632 substitutes θ2 for θ (θ=θ2) because φ2 is closer to θ3 and θ2 is primarily used for the calculation of φ2 (processing D17).

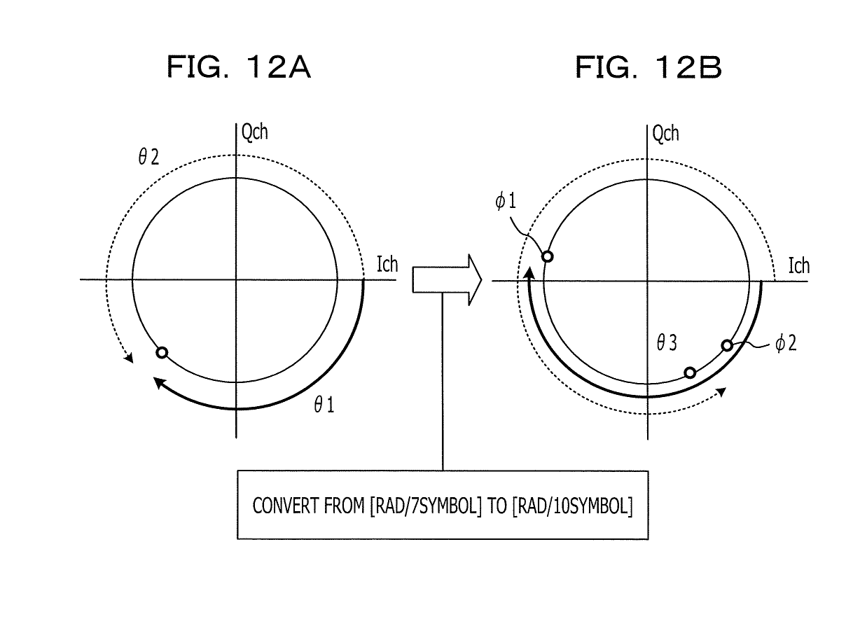

For example, as illustrated in FIGS. 12A and 12B, the case is assumed in which φ1 indicates rotation in the negative direction and is located in the area where I<0 and Q>0 , φ2 indicates rotation in the positive direction and is located in the area where I>0 and Q<0, and θ3 is located in the area where I>0 and Q<0. In this case, φ2 is a value (phase) closer to θ3 compared with φ1, and thus φ2 is selected, and θ2, which is primarily used for the calculation of φ2, is substituted for θ as a correct calculation result.

As illustrated in FIG. 9, the UL reception unit 632 then converts the unit of θ from [rad/7symbol] to [rad/1symbol] by the processing E (processing E11).

As described above, the estimated range of frequency deviation may be expanded in the above-described embodiment, and thus, for example, even in the SCell which does not allow transmission of the PUCCH, frequency deviation estimation in a wide range may be achieved. Consequently, the precision of the estimation of frequency deviation may be improved and the reception characteristics of the eNB 10 may be enhanced.

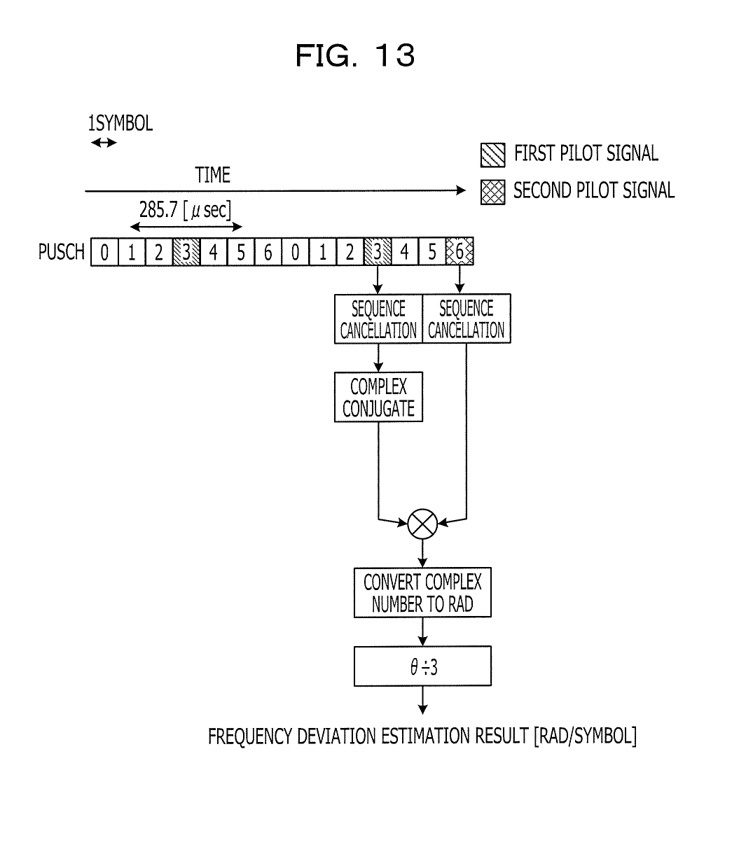

It is to be noted that the method illustrated in FIG. 13 may be used as a frequency deviation estimation method at the timing of receiving the first and second pilot signals in the same time interval (subframe). By the method illustrated in FIG. 13, the product of the complex conjugate of the first pilot signal and the second pilot signal is calculated, and the calculation result is converted into a phase angle per symbol (rad/symbol), thereby determining a frequency deviation.

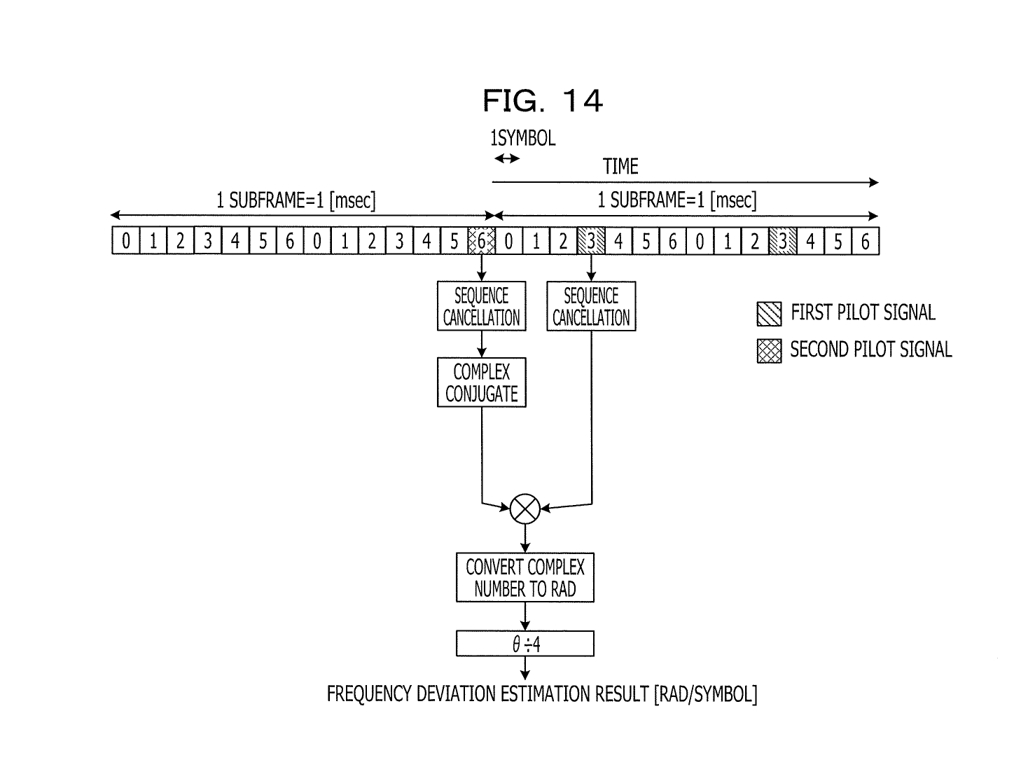

As illustrated in FIG. 14, scheduling may be performed so that the second pilot signal is placed in front of the first pilot signal by one subframe. In this case, the product of the complex conjugate of the second pilot signal and the first pilot signal is calculated, and the calculation result is converted into a phase angle per symbol, thereby determining a frequency deviation.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A scheduling method by a scheduling device, the scheduling method comprising:
receiving a first signal including a plurality of first reference signals from a terminal, the plurality of first reference signals being time multiplexed and having a same frequency;
estimating a frequency deviation of the first signal based on the plurality of first reference signals of the first signal;
transmitting a second signal to the terminal based on the frequency deviation, the second signal instructing the terminal to transmit a third signal in which the plurality of first reference signals and a second reference signal are time multiplexed in a specified period and have a same frequency.

2. The scheduling method according to claim 1, further comprising:
receiving the third signal from the terminal;
estimating a first frequency deviation of the third signal with phase rotation in a positive direction and a second frequency deviation of the third signal with phase rotation in a negative direction based on the plurality of first reference signals;
estimating a direction of phase rotation of the third signal based on the second reference signal and one of the plurality of first reference signals; and
selecting one of the first frequency deviation and the second frequency deviation based on the estimated direction of phase rotation.

3. The scheduling method according to claim 1, wherein
the transmitting of the second signal is performed when an absolute value of the frequency deviation is greater than or equal to a threshold.

4. The scheduling method according to claim 3, wherein
the transmitting of the second signal is not performed when an absolute value of the frequency deviation is less than a threshold.

5. The scheduling method according to claim 1, wherein
the plurality of first reference signals are demodulation reference signals (DM-RS) of a physical uplink shared channel (PUSCH), and the second reference signal is a sounding reference signal (SRS).

6. The scheduling method according to claim 1, wherein
the first signal and the third signal are received via a secondary cell (SCell) of carrier aggregation (CA).

7. The scheduling method according to claim 1, wherein
the specified period corresponds to a subframe.

8. The scheduling method according to claim 1, wherein
the scheduling device is a base station.

9. A scheduling method by a scheduling device, the scheduling method comprising:
receiving a first signal in which a plurality of first reference signals and a second reference signal are time multiplexed in a specified period and have identical frequency, from a terminal;
estimating a first frequency deviation of the first signal with phase rotation in a positive direction and a second frequency deviation of the first signal with phase rotation in a negative direction based on the plurality of first reference signals;
estimating a direction of phase rotation of the first signal based on the second reference signal and one of the plurality of first reference signals; and
selecting one of the first frequency deviation and the second frequency deviation based on the estimated direction of phase rotation.

10. A scheduling device comprising:
a receiver configured to receive a first signal including a plurality of first reference signals from a terminal, the plurality of first reference signals being time multiplexed and having a same frequency;
a processor configured to estimate a frequency deviation of the first signal based on the plurality of first reference signals of the first signal; and
a transmitter configured to transmit a second signal to the terminal based on the frequency deviation, the second signal instructing the terminal to transmit a third signal in which the plurality of first reference signals and a second reference signal are time multiplexed in a specified period and have a same frequency.

11. The scheduling device according to claim 10, wherein
the receiver is further configured to receive the third signal from the terminal, and
the processor is further configured
to estimate a first frequency deviation of the third signal with phase rotation in a positive direction and a second frequency deviation of the third signal with phase rotation in a negative direction based on the plurality of first reference signals,
to estimate a direction of phase rotation of the third signal based on the second reference signal and one of the plurality of first reference signals, and
to select one of the first frequency deviation and the second frequency deviation based on the estimated direction of phase rotation.

12. The scheduling device according to claim 10, wherein
the processor is configured to transmit the second signal to the terminal when an absolute value of the frequency deviation is greater than or equal to a threshold.

13. The scheduling device according to claim 12, wherein
the processor is configured not to transmit the second signal to the terminal when an absolute value of the frequency deviation is less than a threshold.

14. The scheduling device according to claim 10, wherein
the plurality of first reference signals are demodulation reference signals (DM-RS) of a physical uplink shared channel (PUSCH), and the second reference signal is a sounding reference signal (SRS).

15. The scheduling device according to claim 10, wherein
the first signal and the third signal are received via a secondary cell (SCell) of carrier aggregation (CA).

16. The scheduling device according to claim 10, wherein
the specified period corresponds to a subframe.

17. The scheduling device according to claim 10, wherein
the scheduling device is a base station.
